(19) United States
(12) Patent Application Publication
(10) Pub. No.: US 2024/0401665 A1
(43) Pub. Date: Dec. 5, 2024

(54) STRUCTURE, VALVE APPARATUS, AND METHOD OF ASSEMBLING VALVE APPARATUS

(71) Applicant: Hitachi Astemo, Ltd., Hitachinaka-shi, Ibaraki (JP)

(72) Inventors: Tomohiko IIDA, Hitachinaka-shi, Ibaraki (JP); Hiroshi YAMAGAI, Hitachinaka-shi, Ibaraki (JP)

(21) Appl. No.: 18/692,586

(22) PCT Filed: Nov. 16, 2022
(86) PCT No.: PCT/JP2022/042526

§ 371 Date: Mar. 15, 2024

(30) Foreign Application Priority Data
Dec. 27, 2021 (JP) 2021-212683

(51) Int. Cl. F16F 9/38; F16F 9/32; F16K 31/06

(52) U.S. Cl. CPC F16F 9/38; F16F 9/3271; F16K 31/06

(57) ABSTRACT

Water introduced to inside a cover via a space between a cylindrical portion of a first tube of the cover and a solenoid case is discharged out of the cover via a space formed between the cover and an upper-side end portion of a valve case and a plurality of passages formed between a lower-side end portion of a second tube and an upper end portion of a base portion of the valve case, and therefore an uncoated portion inside the cover can be prevented from being rusted.

### TECHNICAL FIELD

The present invention relates to a structure in which a crimped portion between two tubular structures is covered by a cover, a valve apparatus in which a crimped portion between a solenoid tubular structure and a valve tubular structure is covered by a cover, and a method of assembling this valve apparatus.

### BACKGROUND ART

PTL 1 discloses a valve apparatus in which a part of a tubular member (a first tubular structure) containing a solenoid enters an actuator case (a second tubular structure), and the tubular member and the actuator case are joined with each other by crimping them from outside the actuator case (hereinafter referred to as a “conventional valve apparatus”). In the conventional valve apparatus, a crimped portion (a recessed portion) recessed toward the center of the actuator case is protected by a tubular cover attached to the upper end portion of the actuator case.

### CITATION LIST

### Patent Literature

PTL 1: European Patent No. 2628974

### SUMMARY OF INVENTION

### Technical Problem

The conventional valve apparatus (structure) raises such a concern that an uncoated portion remaining on the crimped portion (the recessed portion) may be rusted due to water introduced via a space between the cover and the actuator case.

One object of the present invention is to, in a structure in which a crimped portion between two tubular structures is covered by a cover, a valve apparatus in which a crimped portion between a solenoid tubular structure and a valve tubular structure is covered by a cover, and a method of assembling this valve apparatus, prevent an uncoated portion inside the cover from being rusted.

### Solution to Problem

According to the present invention, a structure includes a unit and a cover. In the unit, at least a part of a first tubular structure enters at least a part of a second tubular structure, crimping is applied from outside the second tubular structure, and a recessed portion recessed toward a central portion of the first tubular structure is formed. The cover includes a tubular portion covering at least a part of the first tubular structure and the second tubular structure, and a fixation portion provided on an inner peripheral side of the tubular portion and fixed by entering the recessed portion from outside the unit.

Further, according to the present invention, a valve apparatus includes a valve unit and a cover. In the valve unit, at least a part of a tube-shaped solenoid tubular structure containing a coil enters at least a part of a tube-shaped valve tubular structure containing a valve, crimping is applied from outside the valve tubular structure, and a recessed portion recessed toward a central portion of the solenoid tubular structure is formed. The cover includes a first tube covering at least a part of the solenoid tubular structure, a second tube covering at least a part of the valve tubular structure, and a fixation portion provided between the first tube and the second tube and fixed by entering the recessed portion.

Further, according to the present invention, in a method of assembling a valve apparatus, the valve apparatus includes a valve unit and a cover. In the valve unit, at least a part of a tube-shaped solenoid tubular structure containing a coil enters at least a part of a tube-shaped valve tubular structure containing a valve, crimping is applied from outside the valve tubular structure, and a recessed portion recessed toward a central portion of the solenoid tubular structure is formed. The cover includes a first tube covering at least a part of the solenoid tubular structure, a second tube covering at least a part of the valve tubular structure, and a fixation portion provided between the first tube and the second tube and fixed by entering the recessed portion. The method of assembling the valve apparatus includes inserting the valve into the valve tubular structure, inserting the coil into the solenoid case tubular structure, pressing and crimping the valve tubular structure toward the recessed portion of the solenoid tubular structure, and inserting a cover outside the solenoid tubular structure and the valve tubular structure.

According to one aspect of the present invention, in a structure in which a crimped portion between two tubular structures is covered by a cover, a valve apparatus in which a crimped portion between a solenoid tubular structure and a valve tubular structure is covered by a cover, and a method of assembling this valve apparatus, an uncoated portion inside the cover can be prevented from being rusted.

### BRIEF DESCRIPTION OF DRAWINGS

FIG. 1 is a front view of a shock absorber to which a valve apparatus according to a first embodiment is applied.

FIG. 2 is a cross-sectional view of a valve unit including a cylinder taken along an axial plane.

FIG. 3 is an enlarged view of main portions illustrated in FIG. 2

FIG. 4 is a perspective view of a cover.

FIG. 5 is an enlarged view of the main portions of the valve unit including the cylinder in cross-section taken along an axial plane different from FIG. 2 (not including protrusions).

FIG. 6 illustrates a second embodiment.

### DESCRIPTION OF EMBODIMENTS

### First Embodiment

A first embodiment of the present invention will be described with reference to the attached drawings.

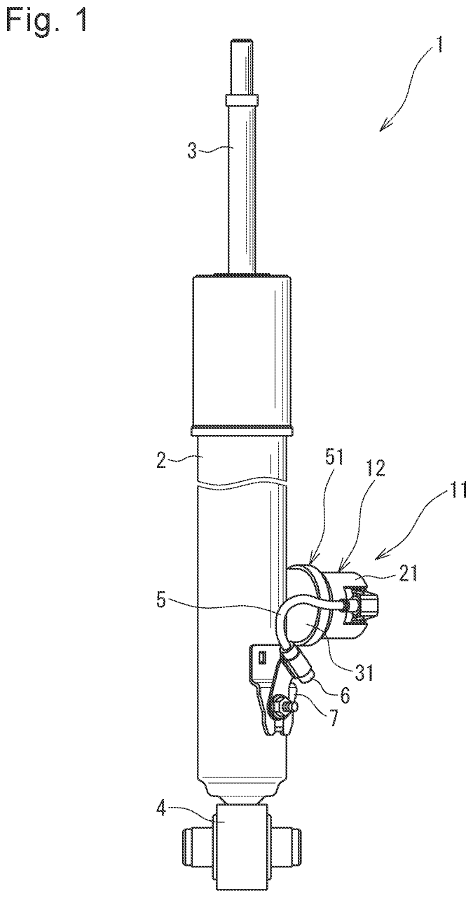

FIG. 1 illustrates a shock absorber 1 to which a valve apparatus 11 (a structure) according to the first embodiment is applied. The shock absorber 1 is a control valve side-mounting damping force adjustable hydraulic shock absorber in which the valve apparatus 11 is attached to the side wall of a cylinder 2 (an outer tube) alongside. The shock absorber 1 includes a piston rod 3 protruding from the cylinder 2 outward, and a mounting eye 4 is provided on the bottom portion of the cylinder 2. A bracket 7 is fixed to the side wall of the cylinder 2. The bracket 7 supports a connector 6 of a cable 5 of the valve apparatus 11.

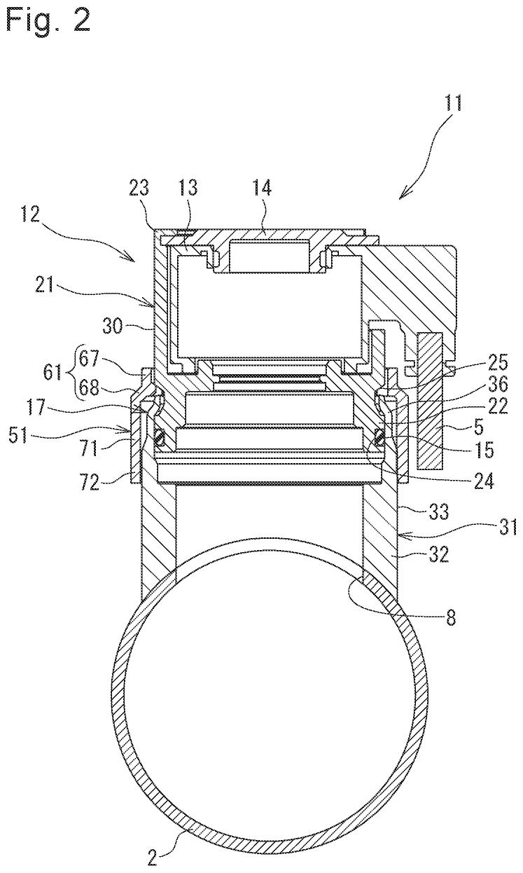

The shock absorber 1 is configured similarly to a conventional control valve side-mounting damping force adjustable hydraulic shock absorber except for a cover 51, which will be described below. In other words, the cover 51 is mountable on an existing shock absorber. In the following description, the detailed description of the control valve side-mounting damping force adjustable hydraulic shock absorber will be omitted for the purpose of simplifying the description of the specification. Further, the vertical direction in FIG. 2 will be referred to as a “vertical direction” or an “axial direction”.

As illustrated in FIG. 2, a cylindrical valve case 31 (a second tubular structure or a valve tubular structure) is provided on the side wall of the cylinder 2 so as to surround an opening 8 of the cylinder 2. A damping valve (a valve, not illustrated) is contained in the valve case 31. An end portion 22 (at least a part of a first tubular structure or a solenoid tubular structure) of a solenoid case 21 (the first tubular structure or the solenoid tubular structure) on the lower side (a cylinder side) is inserted inside an end portion 35 (at least a part of the second tubular structure or the valve tubular structure) of the valve case 31 on the upper side (an opposite side from the cylinder side).

A coil (only a “coil case 13” is illustrated in FIG. 2) is contained in the solenoid case 21. An axial force is applied to an internal component of a solenoid (not illustrated) by crimping an end portion 23 of the solenoid case 21 on the upper side toward the central portion to join the solenoid case 21 and a cover member 14 with each other.

The solenoid case 21 is in abutment with an annular abutment surface 34 provided on the inner side of a base portion 32 (a portion extending from the end portion 35 down) of the valve case 31 via the damping valve (a pilot case). Due to that, the solenoid case 21 is axially positioned relative to the valve case 31. A seal ring 15 seals between the solenoid case 21 and the valve case 31. The seal ring 15 is attached in a seal groove 24 provided on the outer periphery of the lower-side end portion 22 of the solenoid case 21.

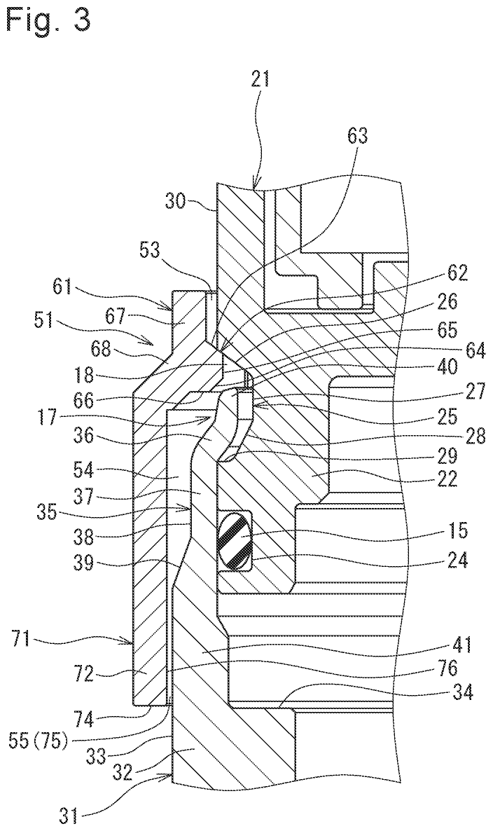

As illustrated in FIG. 3, an outer peripheral groove 25 (a recessed portion) is provided at a portion of the lower-side end portion 22 of the solenoid case 21 that faces an opening edge portion 36 (a portion crimped by a tool) of the valve case 31. The outer peripheral groove 25 is recessed from an outer peripheral surface 30 of the solenoid case 21 toward the central portion. The opening edge portion 36 of the valve case 31 enters the outer peripheral groove 25 at the time of the crimping.

The outer peripheral groove 25 includes an annular inclined surface 26, an annular inclined surface 28, an annular bottom surface 27, and a flange surface 29. The inclined surface 26 is provided on the upper portion of the outer peripheral groove 25, and has a diameter increasing toward the axially upper side. The upper end of the inclined surface 26 is in contact with the outer peripheral surface 30 of the solenoid case 21. The inclined surface 28 is provided on the lower portion of the outer peripheral groove 25, and has a diameter increasing toward the axially lower side. The upper end of the bottom surface 27 is continuous to the lower end of the upper-side inclined surface 26, and the lower end of the bottom surface 27 is continuous to the upper end of the lower-side inclined surface 28. The flange surface 29 is provided on a plan perpendicular to the axis of the solenoid case 21. The end of the flange surface 29 on the radially outer side (the “left side” in FIG. 3) is in contact with the outer peripheral surface 30 of the solenoid case 21, and the end of the flange portion 29 on the radially inner side (the “right side in FIG. 3) is continuous to the lower-side inclined surface 28.

A thin-walled portion 37 is provided on the upper-side end portion 35 of the valve case 31. The thin-walled portion 37 has an outer diameter smaller than the outer diameter of an outer peripheral surface 33 of the base portion 32. Further, an outer tapered surface 39 is provided on the end portion 35 of the valve case 31. The upper end of the outer tapered surface 39 is in contact with the lower end of an outer peripheral surface 38 of the thin-walled portion 37, and the lower end of the outer tapered surface 39 is in contact with the outer peripheral surface 33 of the base portion 32.

A valve unit 12 (a unit) is formed by inserting (fitting) the lower-side end portion 22 of the solenoid case 21 inside the upper-side end portion 35 of the valve case 31, pressing and crimping the opening edge portion 36 of the end portion 35 of the valve case 31 from outside the valve case 31 toward the outer peripheral groove 25 of the solenoid case 21, thereby joining the solenoid case 21 and the valve case 31 with each other. The opening edge portion 36 of the valve case 31 is plastically deformed to enter the outer peripheral groove 25 by the crimping with a starting point therefor placed on a corner portion (a ridge) between the outer peripheral surface 30 of the solenoid case 21 and the flange surface 29 of the outer peripheral groove 25.

An annular gap 18 is formed at a crimped portion 17 between the solenoid case 21 and the valve case 31. The gap 18 is provided between the outer peripheral groove 25 of the solenoid case 21 and the opening edge portion 36 of the valve case 31, more specifically, between the upper-side inclined surface 26 of the outer peripheral groove 25 of the solenoid case 21 and a tip portion 40 (the end of the crimped portion) of the opening edge portion 36 of the valve case 31.

The crimped portion 17 is protected by the cover 51 attached to the valve unit 12. The cover 51 is made from, for example, thermoplastic resin. Referring to FIGS. 2 to 4, the cover 51 includes a first tube 61 and a second tube 71. The first tube 61 covers the end portion 22 of the solenoid case 21 (at least a part of the first tubular structure or the solenoid tubular structure). The second tube 71 covers the end portion 35 of the valve case 31 and an upper end portion 41 of the adjacent base portion 32 (a part of the second tubular structure or the valve tubular structure). The inner diameter and the outer diameter of the second tube 71 are set to larger sizes than the inner diameter and the outer diameter of a cylindrical portion 67 of the first tube 61. The first tube 61 includes the cylindrical portion 67 and a tapered portion 68. The cylindrical portion 67 is located on the upper side. The tapered portion 68 is formed between the lower end of the cylindrical portion 67 and the upper end of the second tube 71. A tubular portion is formed by the first tube 61 and the second tube 71.

A plurality of (“six” in the first embodiment) protrusions 62 (a fixation portion) is provided on the inner side of the first tube 61 of the cover 51 at circumferentially even intervals. The protrusions 62 protrude toward the annular gap 18 of the crimped portion 17. The protrusions 62 each include an inclined surface 63, an inclined surface 64, an inner end surface 65, and a lower surface 66. The inclined surface 63 is provided on the upper portion of the protrusion 62, and is pressed against the upper-side inclined surface 26 of the outer peripheral groove 25 of the solenoid case 21 under elasticity of the material. The inclined surface 64 is provided on the lower portion of the protrusion 62, and faces the tip portion 40 (the end of the crimped portion) of the opening edge portion 36 of the valve case 31 with a predetermined space generated therebetween. The inner end surface 65 is provided between the upper and lower inclined surfaces 63 and 64, and enters the gap 18 of the crimped portion 17. The height of the lower surface 66 in the axial direction (the “vertical direction” in FIG. 3) is approximately equal to the height of the tip portion 40 of the opening edge portion 36 of the valve case 31.

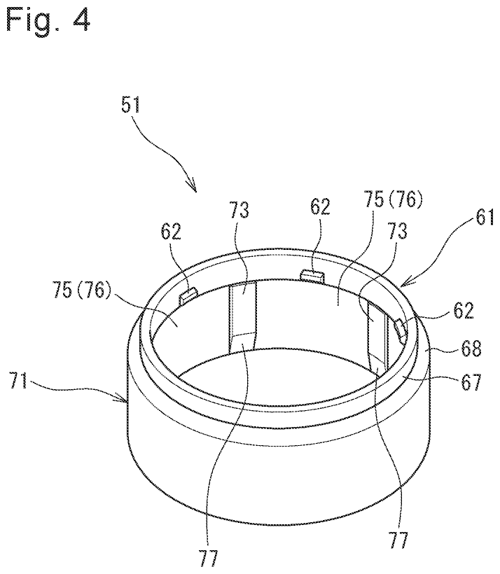

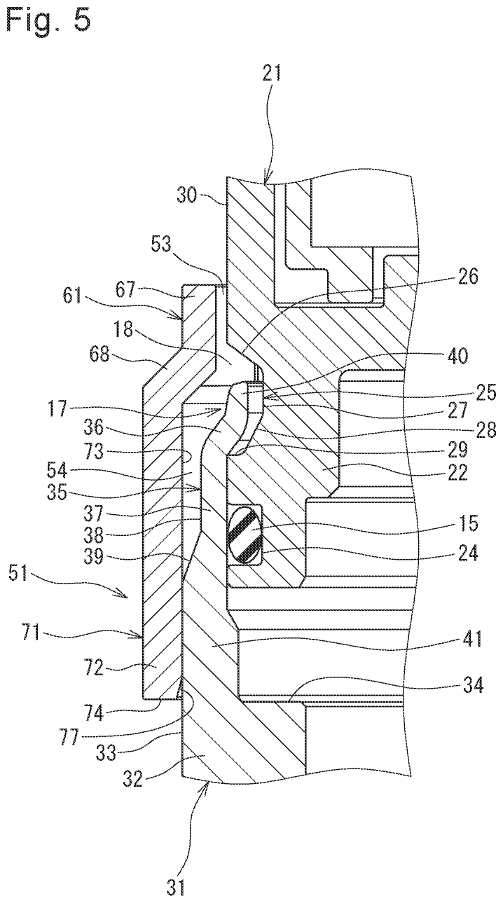

Referring to FIGS. 4 and 5, a plurality of (“six” in the first embodiment) grooves 75 is provided on an inner peripheral surface 73 of the second tube 71 of the cover 51. The grooves 75 extend in the axial direction (the “vertical direction” in FIG. 5) from a lower end surface 74 of the second tube 71 to the lower end of the first tube 61 (the tapered portion 68). The grooves 75 are each formed into a circular-arc shape in cross-section taken along a plane perpendicular to the axis, and are arranged at even intervals in the circumferential direction of the inner peripheral surface 73. In other words, the grooves 75 and the protrusions 62 correspond to each other in a one-on-one manner.

The grooves 75 each have a width sufficiently wide compared to the width of the inner peripheral surface 73 between the adjacent grooves 75 of the second tube 71. An inner tapered surface 77 is provided on the lower end portion of the inner peripheral surface 73 between the adjacent grooves 75 of the second tube 71. The inner tapered surface 77 has a diameter reducing from the lower end surface 74 toward the upper side. The bottom surface of the groove 75 and the inner tapered surface 77 are located on the same circle centered at the axis (the centerline) of the cover 51 on the lower end surface 74 of the second tube 71.

Next, a method of assembling the above-described valve apparatus 11 will be described.

First, the damping valve (the valve, not illustrated), such as a main valve or a pilot valve, is inserted into the valve case 31 (the second tubular structure or the valve tubular structure) of a tube assembly (not illustrated) with the piston rod 3 and the like mounted in the cylinder 2. Further, the internal component such as an armature and a coil (only the “coil case 13” is illustrated in FIG. 2) is inserted into the solenoid case 21 (the first tubular structure or the solenoid tubular structure).

Next, the lower-side end portion 22 of the solenoid case 21 (at least a part thereof) is inserted inside the upper-side end portion 35 of the valve case 31 (at least a part thereof). The solenoid case 21 is axially positioned relative to the valve case 31 by being placed in abutment with the abutment surface 34 of the valve case 31 via the damping valve. Next, the opening edge portion 36 of the end portion 35 of the valve case 31 is pressed toward the outer peripheral groove 25 (the recessed portion) of the solenoid case 21 from outside the valve case 31 using a tool (not illustrated) or the like. As a result, the opening edge portion 36 of the valve case 31 is crimped by being plastically deformed toward the central portion, and the solenoid case 21 and the valve case 31 are joined with each other.

Next, the cover 51 for protecting the crimped portion 17 is attached to the valve unit 12 acquired by joining the solenoid case 21 and the valve case 31. At this time, first, the upper-side end portion 23 of the solenoid case 21 is inserted inside an end portion 72 of the second tube 71 of the cover 51, and the cover 51 is moved downward (toward the cylinder side) relative to the solenoid case 21 (the valve unit 12). In the course of the movement, first, each of the protrusions 62 (the fixation portion) of the cover 51 abuts against the outer corner portion (the ridge) of the end portion 23 of the solenoid case 21, but the lower-side inclined surface 64 of the protrusion 62 of the cover 51 abuts against this corner portion and therefore the protrusion 62 can smoothly pass over the corner portion.

After the protrusion 62 passes over the corner portion of the solenoid case 21, next, the upper end portion 41 of the base portion 32 of the valve case 31 is fitted to the inner peripheral surface 73 of the second tube 71 of the cover 51 as an interference fit. At this time, the valve case 31 can be smoothly fitted (press-fitted) to the second tube 71 because the inner tapered surface 77 is provided at the corner portion between the inner peripheral surface 73 and the lower end surface 74 of the second tube 71 of the cover 51.

Then, in the course of the valve case 31 being fitted (press-fitted) to the second tube 71, when the corner portion (the ridge) between the upper-side inclined surface 63 and the inner end surface 65 of the protrusion 62 of the cover 51 passes over the corner portion (the ridge) between the outer peripheral surface 30 of the solenoid case 21 and the upper-side inclined surface 26 of the outer peripheral groove 25 (the recessed portion), the protrusion 62 protrudes into the gap 18 of the crimped portion 17 under the elasticity of the cover 51, and the upper-side inclined surface 63 of the protrusion 62 is pressed against the upper-side inclined surface 26 of the outer peripheral groove 25. As a result, the cover 51 is fixed to the valve unit 12.

With the cover 51 attached to the valve unit 12, an annular space 53 is formed between the cylindrical portion 67 of the first tube 61 of the cover 51 and the solenoid case 21. Further, an annular space 54 is formed between the cover 51 and the upper-side end portion 35 of the valve case 31. The annular space 54 is in communication with the space 53. Further, a plurality of passages 55 is formed between the lower-side end portion 72 of the second tube 71 of the cover 51 and the upper end portion 41 of the base portion 32 of the valve case 31 due to the grooves 75 formed on the inner peripheral surface 73 of the second tube 71. The space 54 is in communication with the outside (outside the cover 51) via the grooves 55.

Now, the conventional valve apparatus (structure) raises such a concern that the uncoated portion of the valve unit may be rusted due to water introduced to inside the cover protecting the crimped portion of the valve unit.

On the other hand, in the first embodiment, water introduced to inside the cover 51 via the space 53 between the first tube 61 of the cover 51 and the solenoid case 21 (the first tubular structure or the solenoid tubular structure) is discharged out of the cover 51 via the space 54 formed between the cover 51 and the upper-side end portion 35 of the valve case 31 (the second tubular structure or the valve tubular structure) and the plurality of passages 55 formed between the lower-side end portion 72 of the second tube 71 and the upper end portion 41 (the portion to which the end portion 72 of the second tube 71 is fitted) of the base portion 32 of the valve case 31, and therefore an uncoated portion (the crimped portion 17) of the valve unit 12 inside the cover 51 can be prevented from being rusted.

Further, in the first embodiment, the plurality of protrusions 62 (the fixation portion) of the cover 51 enters the outer peripheral groove 25 (the recessed portion) of the solenoid case 21 and the upper-side inclined surfaces 63 of the protrusions 62 are pressed against the upper-side inclined surface 26 of the outer peripheral groove 25 in planar contact, and therefore the cover 51 can be firmly fixed to the valve unit 12 and can be prevented from being detached off.

### Second Embodiment

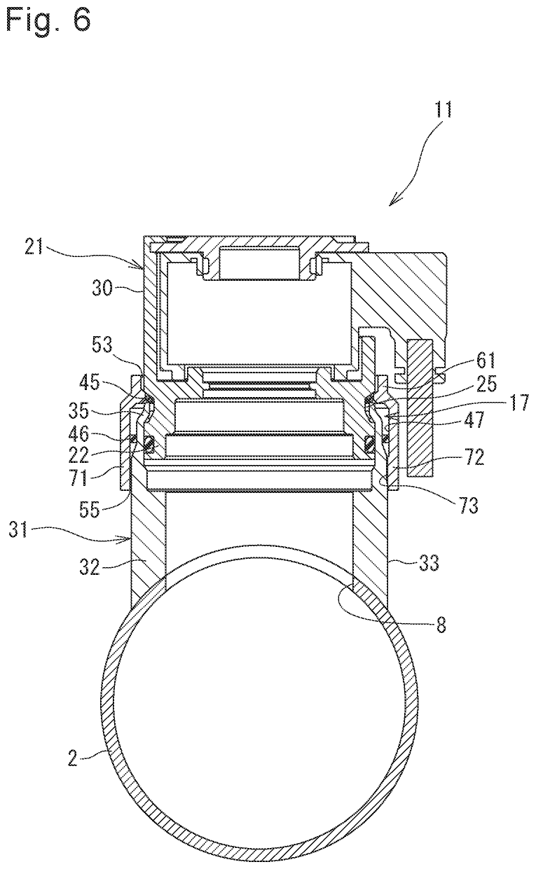

Next, a second embodiment will be described with reference to FIGS. 3 and 6. The second embodiment will be described here, focusing on differences from the first embodiment. The second embodiment will be described, assigning the same names and reference numerals to portions shared with the first embodiment, and also omitting redundant descriptions thereof.

In the first embodiment, the valve apparatus 11 is configured in such a manner that water introduced to inside the cover 51 via the space 53 between the cylindrical portion 67 of the first tube 61 of the cover 51 and the solenoid case 21 is discharged out of the cover 51 via the space 54 formed between the cover 51 and the upper-side end portion 35 of the valve case 31 and the plurality of passages 55 formed between the lower-side end portion 72 of the second tube 71 and the upper end portion 41 of the base portion 32 of the valve case 31.

On the other hand, in the second embodiment, the valve apparatus 11 is constructed with a first seal ring 45 (a first seal portion or a seal member) provided between the solenoid case 21 (the first tubular structure or the solenoid tubular structure) and the first tube 61 of the cover 51, and a second seal ring 46 (a second seal portion or a seal member) also provided between the valve case 31 (the second tubular structure or the valve tubular structure) and the second tube 71 of the cover S1.

The first seal ring 45 is provided between the gap 18 formed at the crimped portion 17 between the solenoid case 21 and the valve case 31 and the protrusion 62 of the cover 51 entering this gap 18. The first seal ring 45 is pressed against the upper-side inclined surface 26 of the outer peripheral groove 25 of the solenoid case 21, the tip portion 40 (the end of the crimped portion) of the opening edge portion 36 of the valve case 31, and the inner end surface 65 of the protrusion 62 of the cover 51. On the other hand, the second seal ring 46 is compressed between the second tube 71 of the cover 51 and the thin-walled portion 37 of the end portion 35 of the valve case 31. The second seal ring 46 is in contact with an inner cylindrical surface 47 formed on the second tube 71. The inner cylindrical surface 47 is provided on the same cylindrical surface as the bottom surface of the groove 75.

In the second embodiment, water introduced into the space 53 between the cylindrical portion 67 of the first tube 61 of the cover 51 and the solenoid case 21 can be prevented from entering the uncoated portion (the crimped portion 17) of the valve unit 12 inside the cover 51 with the aid of the first seal ring 45 (the first seal portion or the seal member) provided between the solenoid case 21 (the first tubular structure or the solenoid tubular structure) and the first tube 61 of the cover 51.

Further, in the second embodiment, water introduced into the plurality of passages 55 formed between the lower-side end portion 72 of the second tube 71 and the upper end portion 41 (the portion to which the end portion 72 of the second tube 71 is fitted) of the base portion 32 of the valve case 31 can be prevented from entering the uncoated portion (the crimped portion 17) of the valve unit 12 inside the cover 51 with the aid of the second seal ring 46 (the second seal portion or the seal member) provided between the valve case 31 (the second tubular structure or the valve tubular structure) and the second tube 71 of the cover 51.

According to the second embodiment. the uncoated portion (the crimped portion 17) of the valve unit 12 inside the cover 51 can be prevented from being rusted.

In the second embodiment, the valve apparatus 11 is configured in such a manner that the first seal ring 45 is provided between the gap 18 and the protrusion 62 of the cover 51 entering this gap 18, but may be configured in such a manner that an annular seal member is provided so as to cover the inner and outer peripheries of the cylindrical portion 67 of the first tube 61. Similarly, the valve apparatus 11 is configured in such a manner that the second seal ring 46 is provided between the second tube 71 of the cover 51 and the thin-walled portion 37 of the end portion 35 of the valve case 31, but may be configured in such a manner that an annular seal member is provided so as to cover the inner and outer peripheries of the end portion 72 of the second tube 71 of the cover 51.

The above-described embodiments have been described regarding the example in which the present invention is applied to the valve apparatus of the shock absorber, but this is not intended to limit the present invention to the application to the valve apparatus of the shock absorber.

Further, the present invention can be applied to a cover that protects a crimped portion (a joined portion) when two tubular structures are joined with each other by crimping.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-212683 filed on Dec. 27, 2021. The entire disclosure of Japanese Patent Application No. 2021-212683 filed on Dec. 27, 2021 including the specification, the claims, the drawings, and the abstract is incorporated herein by reference in its entirety.

### REFERENCE SIGNS LIST

11 valve apparatus (structure)
12 valve unit (unit)
21 solenoid case (first tubular structure or solenoid tubular structure)
22 end portion (at least a part)
25 outer peripheral groove (recessed portion)
31 valve case (second tubular structure or valve tubular structure)
35 end portion (at least a part)
51 cover
61 first tube
71 second tube

1. A structure comprising:
a unit in which at least a part of a first tubular structure enters at least a part of a second tubular structure, crimping is applied from outside the second tubular structure, and a recessed portion recessed toward a central portion of the first tubular structure and partially facing a crimped portion of the second tubular structure is formed; and
a cover including a tubular portion covering at least a part of the first tubular structure and the second tubular structure, and a fixation portion provided on an inner peripheral side of the tubular portion and fixed by entering a remaining portion of the recessed portion from outside the unit.

2. The structure according to claim 1, wherein the tubular portion includes a first tubular portion covering the first tubular structure and a second tubular portion covering the second tubular structure,
wherein the fixation portion is provided between the first tubular portion and the second tubular portion and partially in a circumferential direction of the tubular portion, and
wherein an abutment portion in abutment with the second tubular structure is provided partially in a circumferential direction of the second tubular portion on an inner periphery of the second tubular portion.

3. A valve apparatus comprising:
a valve unit in which at least a part of a tube-shaped solenoid tubular structure containing a coil enters at least a part of a tube-shaped valve tubular structure containing a valve, crimping is applied from outside the valve tubular structure, and a recessed portion recessed toward a central portion of the solenoid tubular structure and partially facing a crimped portion of the valve tubular structure is formed; and
a cover including a first tube covering at least a part of the solenoid tubular structure, a second tube covering at least a part of the valve tubular structure, and a fixation portion provided between the first tube and the second tube and fixed by entering a remaining portion of the recessed portion.

4. The valve apparatus according to claim 3, wherein a space is formed between the solenoid tubular structure and the first tube and between the valve tubular structure and the second tube.

5. The valve apparatus according to claim 3, wherein a first seal portion and a second seal portion are formed between the solenoid tubular structure and the first tube, and between the valve tubular structure and the second tube.

6. The valve apparatus according to claim 5, wherein the first seal portion and the second seal portion are seal members provided as members different from the cover.

7. The valve apparatus according to claim 5, wherein the first seal portion and the second seal portion are formed integrally with the cover.

8. A method for assembling a valve apparatus,
the valve apparatus including
a valve unit in which at least a part of a tube-shaped solenoid tubular structure containing a coil enters at least a part of a tube-shaped valve tubular structure containing a valve, crimping is applied from outside the valve tubular structure, and a recessed portion recessed toward a central portion of the solenoid tubular structure and partially facing a crimped portion of the valve tubular structure is formed, and
a cover including a first tube covering at least a part of the solenoid tubular structure, a second tube covering at least a part of the valve tubular structure, and a fixation portion provided between the first tube and the second tube and fixed by entering a remaining portion of the recessed portion,
the method for assembling the valve apparatus comprising:
inserting the valve into the valve tubular structure;
inserting the coil into the solenoid tubular structure;
pressing and crimping the valve tubular structure toward the recessed portion of the solenoid tubular structure; and
inserting a cover outside the solenoid tubular structure and the valve tubular structure.
